(19) United States
(12) Patent Application Publication
(10) Pub. No.: US 2013/0300203 A1
(43) Pub. Date: Nov. 14, 2013

(54) WIRELESS ELECTRICAL POWER TRANSMISSION SYSTEM AND ITS CONTROL METHOD

(71) Applicants: Dan Li, Qingdao City (CN); Xiulian Dong, Qingdao City (CN); Chao Qin, Qingdao City (CN); Bingbing Lou, Qingdao City (CN); Ming Li, Qingdao City (CN)

(72) Inventors: Dan Li, Qingdao City (CN); Xiulian Dong, Qingdao City (CN); Chao Qin, Qingdao City (CN); Bingbing Lou, Qingdao City (CN); Ming Li, Qingdao City (CN)

(73) Assignees: HAIER GROUP TECHNOLOGY R&D CENTER, Shandong (CN); HAIER GROUP CORPORATION, Shandong (CN)

(21) Appl. No.: 13/821,563

(22) PCT Filed: Jan. 30, 2011
(86) PCT No.: PCT/CN2011/070814

§ 371 Date: May 7, 2013

(51) Int. Cl. H02J 17/00

(52) U.S. Cl. CPC H02J 17/00
USPC 307/104

(57) ABSTRACT

The present invention provides a wireless electrical power transmission system and its control method with good thermal stability. Said system, comprising a transmitting coil frequency generating part and a coil frequency phase tracking and feedback part, the transmitting coil frequency generating part composed of a control circuit, a driving circuit and an inverter circuit, the coil frequency phase tracking and feedback part composed of a frequency detection circuit and a phase locked loop circuit, is characterized in that said control circuit is controlled by software to output two opposite control signals, each of which controls opening and closing of a switch tube after passing through the driving circuit to generate high-frequency oscillation in the coil.

### TECHNICAL FIELD

The present application relates to a wireless electrical power transmission system with good thermal stability and its control method.

### TECHNICAL BACKGROUND

With the progress of science and technologies, wireless electrical power transmission technologies have been increasingly applied universally, which makes people's lives easier and more convenience, without the fetter of various power wires. Currently, some small-sized electronic devices may be charged in a wireless power supplying manner. For example, electronic devices such as a wireless charger, a wireless rechargeable mouse and a mobile phone may be automatically charged by a wireless power supplying device.

For a wireless power supplying system of medium power (e.g. hundreds of watts), its primary side (i.e. the transmitting side) and tis secondary side (i.e. the receiving side) are operated in a deep coupled and synchronized state because of the large power, and a resonance circuit is typically employed as an output stage. Due to influence by factors such as component parameters and environment, a drift of a coil resonance frequency may be caused, which results in energy transmission in the system deflecting from the predetermined frequency point, thereby reducing the efficiency of the energy transmission; further, an energy loss may cause increased temperature of the coil and devices, and the resultant change of the parameter of the functional device, which varies with the environmental change, will be accumulated and cause the frequency drift, thereby forming a vicious cycle. As a result, a system failure may be caused, even the equipment might be destroyed.

Currently, the solution for solving the above problems focuses on enabling the frequency stability. However, due to the inherent nature of physical properties of the devices per se, it is difficult to solve the problems fundamentally.

### SUMMARY OF THE INVENTION

An object of the present invention is to provide a wireless electrical power transmission system with good thermal stability and its control method, to achieve the stable temperature increase, improve the transmission efficiency of the system, and reduce the heat load of the system.

In the technical solution of the present invention, the system is controlled by software, to eliminate the frequency point drift caused by the parameter of the device per se and the environmental temperature, precisely control the alternating current frequency characteristic and the frequency point of the wireless electrical power transmission circuit, solve the heat generation problem of the critical component, improve the power transmission efficiency of the wireless electrical power transmission circuit.

In the method, the operating frequency of the primary coil is controlled and adjusted in real-time by software, so that the system is operated stably at the frequency point, the transmission of the active power is improved, and the generation of the reactive power is reduced, thereby enhancing the transmission efficiency of the wireless power supplying system, while eliminating the heat generation problem of the coil and the device. The method may be implemented by integrated circuits, so that the circuit design is simplified and the security and stability of the system is improved.

The object of the present invention may be achieved as follows. The frequency of the transmitting coil is controlled by software, and the frequency drift caused by the parameter difference of the device per se is reduced as compared to the implementation of the hardware circuit; the frequency of the coil is tracked and adjusted in a real-time manner by software according to a real-time phase, to continuously approximate to the predetermined frequency point, so that the system can be operated stably at the frequency point, the system transmission efficiency is improved, and the heat generation problem is reduced; the opening and closing of a switching tube in an inverter circuit is controlled by software, thus a large current which is formed in the system loop due to the simultaneous opening of the switching tube is avoided, and the heat generation of the coil and devices is avoided; and the discontinuous energy transmission caused by the simultaneous opening or closing of the switching tube is also avoided.

A control method of the wireless electrical power transmission system of the present invention includes steps of:

providing control signals P1 and P2 with a frequency fp by a control circuit according to a frequency point fk, where fp=fk;

opening or closing a switching tube by a driving circuit according to the control signals P1 and P2, so that an alternating voltage is formed at both ends of a transmitting coil, so that the high-frequency oscillation of the transmitting coil is started;

obtaining a frequency f of the transmitting coil, after the voltage sampling by a voltage comparison circuit;

processing the signal of the frequency f of the transmitting coil through a phase locked loop circuit, and feeding the processed signal back to the control circuit together with the phase difference signal;

adjusting outputs of the control signals P1 and P2 by the control circuit according to the feedback signal; and

repeating the above steps, so that the system is operated stably at the frequency point.

The wireless electrical power transmission system of the present invention includes a transmitting coil frequency generating part and a coil frequency phase tracking and feedback part, where the transmitting coil frequency generating part includes a control circuit, a driving circuit and an inverter circuit, and the coil frequency phase tracking and feedback part includes a frequency detection circuit and a phase locked loop circuit.

With respect to the transmitting coil frequency generating part, the control circuit is controlled by software to output two opposite control signals, each of which controls the opening and closing of a switching tube after passing through the driving circuit, to alternatively generate voltages V1 and V2 for the transmitting coil, so that high-frequency oscillation is formed in the coil to enable energy transmission. Depending on the resonance frequency, the control circuit may generate two signals P1 and P2, which are opposite under the control of software and more precise compared with that under the control of implementation purely by hardware LC circuits. Thus, standard alternating voltages can be formed at both ends of the transmitting coil.

With respect to the coil frequency phase tracking and feedback part, voltages V1 and V2 at both ends of the transmitting coil are sampled, and then compared by a voltage comparison circuit to obtain an oscillation frequency f in the transmitting coil. Specifically, if V1>V2, a voltage comparator in the voltage comparison circuit outputs a high level, and if V1<V2, the voltage comparator outputs a low level, thereby obtaining the oscillation frequency f of the transmitting coil. A frequency f0 is obtained after the oscillation frequency f of the transmitting coil is processed by a phase comparator and a Voltage Controlled Oscillator (VCO). Eventually, f0=f because of the effect of the phase locked loop. A phase difference signal Δφ may be generated during the comparison between the frequencies f and f0. The oscillation frequency f of the transmitting coil and the phase difference signal Δφ are fed back to the control circuit, which then compares the frequency f0 with the fixed frequency point fk to obtain the size of the frequency drift, and then adjusts the frequency fp of the signals P1 and P2 according to the least square method or the median method. The frequency fp is compared and adjusted continuously in the system and eventually the frequency f is equal to the fixed frequency point fk, so that the system can be stabilized at the frequency point for energy transmission. The phase difference signal Δφ may be used by the control circuit to finely tune and output the delay of outputting the signals P1 and P2.

The phase locked loop is used to eliminate the drift phenomenon caused by a clock delay in a chip. The frequency signal is inputted to the phase locked loop to allow the consistency between the phase frequency of the frequency signal and that of a reference signal, so that the data drift phenomenon can be eliminated.

As described above, the wireless electrical power transmission system with good thermal stability includes the transmitting coil frequency generating circuit and the coil frequency phase tracking and feedback circuit, where the transmitting coil frequency generating circuit includes the control circuit, the driving circuit and the inverter circuit, and the coil frequency phase tracking and feedback circuit includes the frequency detection circuit and the phase locked loop circuit.

It is characterized in that the control circuit is controlled by software to output two opposite control signals, each of which controls the opening and closing of a switching tube after passing through the driving circuit, to alternatively generate voltages V1 and V2 for the transmitting coil and form high-frequency oscillation in the coil.

Depending on the resonance frequency, the control circuit may generate two signals P1 and P2, which are opposite under the control of software and more precise compared with that under the control of implementation purely by hardware LC circuits. Thus, standard alternating voltages can be formed at both ends of the transmitting coil.

The inconsistency of parameters of the system device, and variation of the device parameter due to heat generation of the system, may also cause the frequency drift. In this case, a phase tracking circuit may be used to solve the problem of the frequency drift.

The switching tubes would be opened or closed simultaneously due to the asynchronization of hardware switches. If the switching tubes in the inverter circuit are opened at the same time, then a large current will be generated in the loop, thus the temperatures of the device and the coil will be increased, and the system will generate heat. The simultaneous opening or closing of the switching tubes will disable the oscillation of the transmitting coil, and therefore disable the energy transmission.

The control signal may be delayed and tailed due to the difference of the device parameter or the influence of the environmental factor on the device parameter, resulting in the drift of the frequency point, as well as the phenomenon of the energy transmission interruption.

The inverter circuit is controlled precisely by software, so that the maximum active power and the minimum reactive power of the system are achieved. Therefore, the energy transmission efficiency of the system is improved while reducing the heat generation of system caused by the reactive power.

The advantage of the invention lies in that: the frequency of the transmitting coil is controlled by software, and the frequency drift caused by the parameter difference of the device per se is reduced as compared to the implementation of the hardware circuit.

The frequency of the coil is tracked and adjusted in a real-time manner by software according to a real-time phase, to continuously approximate to the predetermined frequency point, so that the system can be operated stably at the frequency point, the system transmission efficiency is improved, and the heat generation problem is reduced.

The precise control of the frequency point of the wireless electrical power transmission circuit, including the control of frequency and timing, are achieved by a Complex Programmable Logic Device (CPLD).

The opening and closing of a switching tube in an inverter circuit is controlled by software, thus a large current which is formed in the system loop due to the simultaneous opening of the switching tube is avoided, and the heat generation of the coil and devices is avoided; and the discontinuous energy transmission caused by the simultaneous opening or closing of the switching tube is also avoided.

1. Through the control by software, the frequency drift caused by parameter of the device per se and the environmental temperature is reduced, to achieve the precise control of the frequency point of the frequency wireless electrical power transmission circuit and alternating current frequency characteristics.

2. By the software-controlled method, the frequency of the coil can be quickly moved to the predetermined frequency point, for the purpose of stable operation.

3. The heat generation problem of key devices can be eliminated, to reduce the reactive power of the entire system, extend the circuit life, and improve the transmission efficiency of the wireless electrical power transmission circuit.

### DESCRIPTION OF DRAWINGS

FIG. 1 is a block diagram showing the overall structure of the primary side of the system of the present invention.

FIG. 2 is a block diagram showing control, driving and inverter parts of the present invention.

FIG. 3 is a diagram showing the standard alternating voltage waveform formed at both output ends of an inverter at the primary side.

FIG. 4 is a diagram showing the alternating voltage waveform caused by asynchronization of the hardware switches.

FIG. 5 is a diagram showing the delayed and tailed waveform of the control signal caused by the device.

FIG. 6 is a block diagram showing the coil frequency phase tracking and feedback part of the present invention.

FIG. 7 is a main flow chart of the control of the present invention.

### DETAILED DESCRIPTION OF THE PREFERRED EMBODIMENT

The wireless electrical power transmission system of the present invention includes a transmitting coil frequency generating part and a coil frequency phase tracking and feedback part. The transmitting coil frequency generating part includes a control circuit, a driving circuit and an inverter circuit, and the coil frequency phase tracking and feedback part includes a frequency detection circuit and a phase locked loop circuit.

The specific connection structure of the system is as follows.

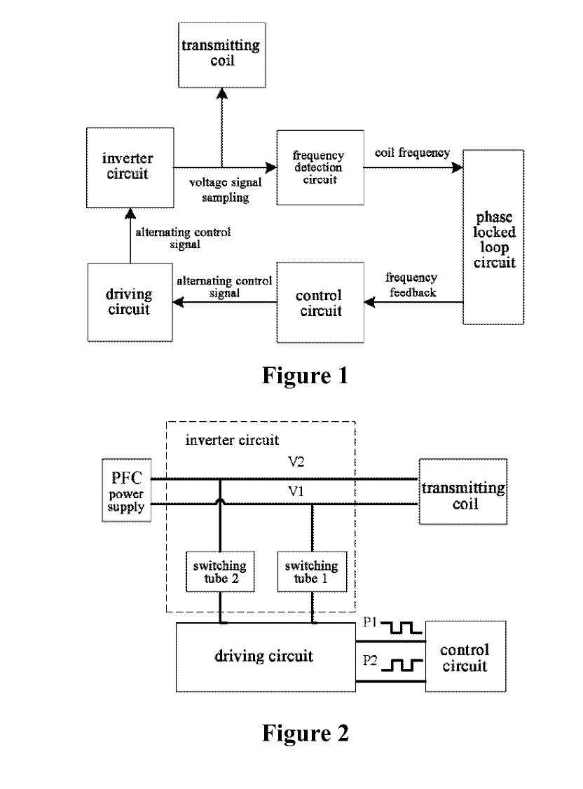

Referring to FIG. 1, with respect to the transmitting coil frequency generating part, the control circuit refers to a Microprogrammed Control Unit (MCU) and its associated circuitry, and its output port is connected to the driving circuit; output ends of the driving circuit are respectively connected with control electrodes of a switching tube of the inverter circuit, thus constituting software-controlled frequency generating and controllable inverter circuits. The control circuit is controlled by software to output two opposite control signals, each of which controls the opening and closing of a switching tube after passing through the driving circuit, to alternatively generate voltages V1 and V2 for the transmitting coil, so that high-frequency oscillation is formed in the coil to enable energy transmission. Depending on the resonance frequency, the control circuit may generate two signals P1 and P2, which are opposite under the control of software and more precise compared with that under the control of implementation purely by hardware LC circuits. Thus, standard alternating voltages can be formed at both ends of the transmitting coil.

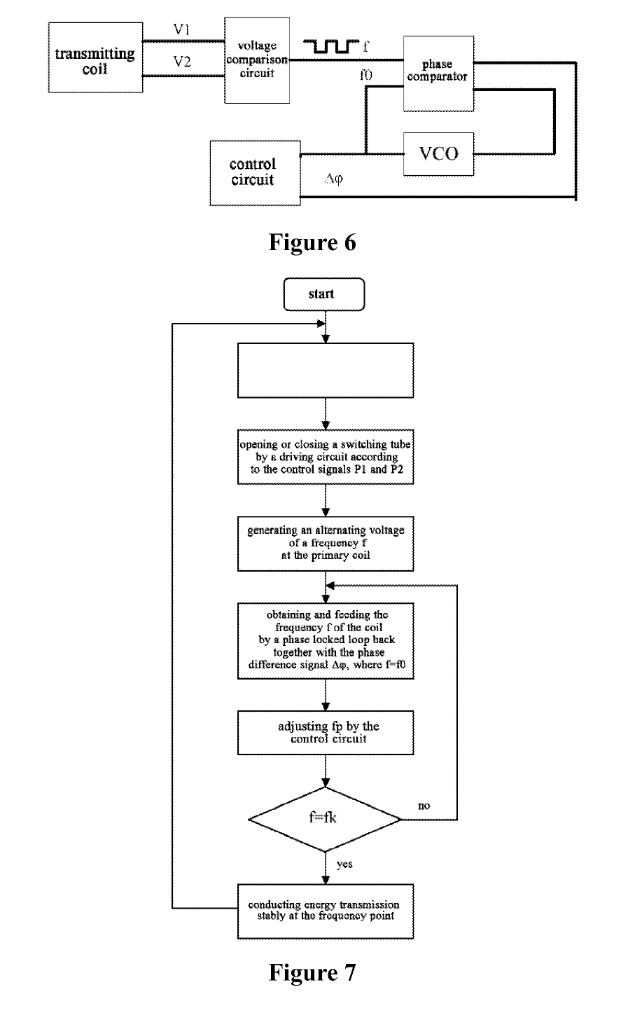

Referring to FIGS. 2 and 6, the coil frequency phase tracking and feedback part includes a frequency voltage sampling circuit and a phase locked loop circuit, and the signal output end of the phase locked loop circuit is connected to the control port of the control circuit.

With respect to the coil frequency phase tracking and feedback part, voltages V1 and V2 at both ends of the transmitting coil are sampled, and then compared by a voltage comparison circuit to obtain an oscillation frequency f in the transmitting coil. Specifically, if V1>V2, a voltage comparator in the voltage comparison circuit outputs a high level, and if V1<V2, the voltage comparator outputs a low level, thereby obtaining the oscillation frequency f of the transmitting coil. A frequency f0 is obtained after the oscillation frequency f of the transmitting coil is processed by a phase comparator and a Voltage Controlled Oscillator (VCO). Eventually, f0=f because of the effect of the phase locked loop. A phase difference signal Δφ may be generated during the comparison between the frequencies f and f0. The oscillation frequency f of the transmitting coil and the phase difference signal Δφ are fed back to the control circuit, which then compares the frequency f0 with the fixed frequency point fk to obtain the size of the frequency drift, and then adjusts the frequency fp of the signals P1 and P2 according to the least square method or the median method. The frequency fp is compared and adjusted continuously in the system and eventually the frequency f is equal to the fixed frequency point fk, so that the system can be stabilized at the frequency point for energy transmission. The phase difference signal Δφ may be used by the control circuit to finely tune and output the delay of outputting the signals P1 and P2.

The phase locked loop is used to eliminate the drift phenomenon caused by a clock delay in a chip. The frequency signal is inputted to the phase locked loop to allow the consistency between the phase frequency of the frequency signal and that of a reference signal, so that the data drift phenomenon can be eliminated.

As described above, the wireless electrical power transmission system with good thermal stability includes the transmitting coil frequency generating circuit and the coil frequency phase tracking and feedback circuit, where the transmitting coil frequency generating circuit includes the control circuit, the driving circuit and the inverter circuit, and the coil frequency phase tracking and feedback circuit includes the frequency detection circuit and the phase locked loop circuit. The control circuit is controlled by software to output two opposite control signals, each of which controls the opening and closing of a switching tube after passing through the driving circuit, to form the high-frequency oscillation in the transmitting coil.

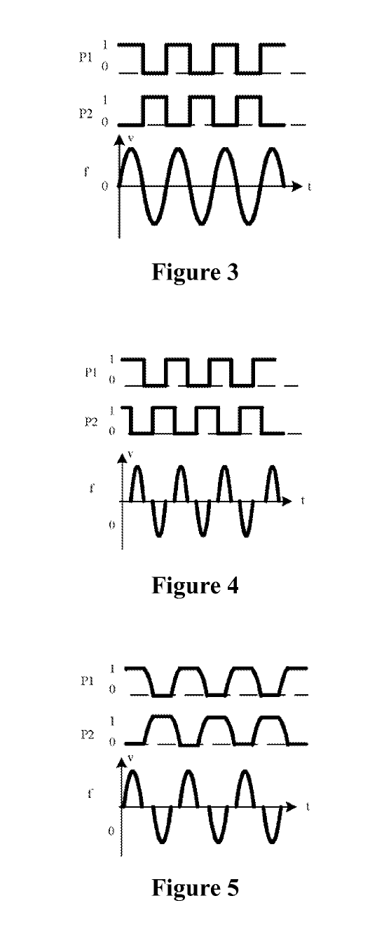

Depending on the resonance frequency, the control circuit may generate two signals P1 and P2, which are opposite under the control of software and more precise compared with that under the control of implementation purely by hardware LC circuits. Thus, standard alternating voltages can be formed at both ends of the transmitting coil, as shown in FIG. 3.

Referring to FIG. 5, the inconsistency of parameters of the system device, and variation of the device parameter due to heat generation of the system, may also cause the frequency drift. In this case, a phase tracking circuit may be used to solve the problem of the frequency drift.

Referring to FIG. 4, the switching tubes would be opened or closed simultaneously due to the asynchronization of hardware switches. If the switching tubes in the inverter circuit are opened at the same time, then a large current will be generated in the loop, thus the temperatures of the device and the coil will be increased, and the system will generate heat. The simultaneous opening or closing of the switching tubes will disable the oscillation of the transmitting coil, and therefore disable the energy transmission.

The control signal may be delayed and tailed due to the difference of the device parameter or the influence of the environmental factor on the device parameter, resulting in the drift of the frequency point, as well as the phenomenon of the energy transmission interruption.

Referring to FIG. 7, a control method of the wireless electrical power transmission system of the present invention includes steps of:

providing control signals P1 and P2 with a frequency fp by a control circuit according to a frequency point fk, where fp=fk;

opening or closing a switching tube by a driving circuit according to the control signals P1 and P2, so that an alternating voltage is formed at both ends of a transmitting coil, so that the high-frequency oscillation of the transmitting coil is started;

obtaining a frequency f of the transmitting coil, after the voltage sampling by a voltage comparison circuit;

processing the signal of the frequency f of the transmitting coil through a phase locked loop circuit, and feeding the processed signal back to the control circuit together with the phase difference signal;

adjusting outputs of the control signals P1 and P2 by the control circuit according to the feedback signal; and

repeating the above steps, so that the system is operated stably at the frequency point.

The inverter circuit is controlled precisely by software, so that the maximum active power and the minimum reactive power of the system are achieved. Therefore, the energy transmission efficiency of the system is improved while reducing the heat generation of system caused by the reactive power.

The above description merely relates to the preferred embodiments of the present invention, and is not intended to limit the present invention in any case. Although the present invention has been disclosed with the above preferred embodiment, the embodiment is not intended to limit the present invention. Those skilled in the art can amend and modify the above disclosed technical contents as equivalent embodiments, without departing from the scope of the technical solution of the present invention. However, the contents without departing from the technical solution of the present invention, any amendments, equivalent variations and modifications of the above embodiments based on the technical essence of the present invention, should fall into the scope of the technical solution of the present invention.

1. A wireless electrical power transmission system, comprising a transmitting coil frequency generating circuit and a coil frequency phase tracking and feedback circuit, wherein the transmitting coil frequency generating circuit includes a control circuit, a driving circuit and an inverter circuit, characterized in that:
the control circuit is controlled by software to output two opposite control signals, each of which controls the opening and closing of a switching tube after passing through the driving circuit, to form high-frequency oscillation in the transmitting coil.

2. The system of claim 1, wherein the control circuit of the transmitting coil frequency generating circuit includes a Microprogrammed Control Unit, and an output port of the control circuit is connected to the driving circuit, output ends of the driving circuit are respectively connected with control electrodes of a switching tube of the inverter circuit, constituting software-controlled frequency generation and controllable inverter circuits.

3. The system of claim 1, wherein the coil frequency phase tracking and feedback circuit includes a frequency voltage sampling circuit and a phase locked loop circuit, and a signal output end of the phase locked loop circuit is connected to a control port of the control circuit.

4. A control method of a wireless electrical power transmission system, characterized by comprising steps of:
providing control signals P1 and P2 with a frequency fp by a control circuit according to a frequency point fk, wherein fp=fk;
opening or closing a switching tube by a driving circuit according to the control signals P1 and P2, so that an alternating voltage is formed at both ends of a transmitting coil, so that high-frequency oscillation of the transmitting coil is started;
obtaining a frequency f of the transmitting coil, after the voltage sampling by a voltage comparison circuit;
processing the signal of the frequency f of the transmitting coil through a phase locked loop circuit, and feeding the processed signal back to the control circuit together with a phase difference signal;
adjusting outputs of the control signals P1 and P2 by the control circuit according to the feedback signal; and
repeating the above steps, so that the system is operated stably at the frequency point.
